(19) United States
(12) Patent Application Publication
(10) Pub. No.: US 2025/0168274 A1
(43) Pub. Date: May 22, 2025

(54) TELECOMMUNICATIONS SYSTEM FOR BLOCKING SPOOFED CALLS

(71) Applicant: T-Mobile USA, Inc., Bellevue, WA (US)

(72) Inventors: Homer Nicolas Filart, Renton, WA (US); Dinko Georgiev Dinkov, Kirkland, WA (US)

(21) Appl. No.: 18/516,715

(22) Filed: Nov. 21, 2023

(51) Int. Cl. H04M 3/42; H04L 65/1016; H04L 65/1104; H04M 3/436

(52) U.S. Cl. CPC H04M 3/42059; H04L 65/1016; H04L 65/1104; H04M 3/436; H04M 2203/6027

(57) ABSTRACT

A system of a telecommunications network that blocks spoofed calls. The system includes an interconnect session border controller (I-SBC) that can receive an inbound call over a network interface. The inbound call is associated with an identifier (e.g., a Session Initiation Protocol (SIP) identifier). The I-SBC causes a Spoofed Call Identification Function (SCIF) to compare the SIP identifier of the inbound call against a list of allowable SIP identifiers. In one example, the I-SBC receives an indication from the SCIF that the SIP identifier of the inbound call does not match any identifier on the list of allowable SIP identifiers. As such, the system rejects the inbound call as an illegitimate call. The illegitimate call is not forwarded to an IP Multimedia Subsystem (IMS) of the telecommunications network.

### BACKGROUND

Call spoofing is the practice of causing a telephone network to indicate to the receiver of a call that the originator of the call is a station other than the true originating station. This can lead to the receiver's phone display showing a phone number different from that of the telephone from which the call was placed. The term “call spoofing” is commonly used to describe situations in which the motivation is considered malicious by the originator. In recent years, malicious actors have used easily available open-source software to spoof calls with minimal costs and effort, resulting in billions of spoofed calls being placed per month. Such spoofed calls are not only annoying to receivers but also stress network resources and reduce network capacity.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an example of a system configured to block spoofed calls on a telecommunications network.

FIG. 4 is a flowchart that illustrates a process for blocking spoofed calls on a telecommunications network.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a telecommunications system for rejecting inbound spoofed calls made to a telecommunications network operator's customers that appear to come from legitimate phone numbers belonging to the operator's other customers. In one implementation of the technology, a legitimate call from the operator's customer is identified by appending a custom identifier to the call's Session Initiation Protocol (SIP) header. A Spoofed Call Identification Function (SCIF) is pre-configured to assess the authenticity of an inbound call based on at least one criterion. The SCIF may use the at least one criterion by itself or in combination with multiple criteria to assess the authenticity of a call. The criterion can be a call attribute. One such criterion is a list of allowable SIP identifiers that identify an inbound call as legitimate. Another such criterion is a list of allowable phone numbers. Yet another such criterion is a list of allowable IP addresses. The pre-configured list of allowable call attributes may be static, updated periodically, or updated in near real time.

The SCIF has at least one network interface over which it is connected to a session border controller (SBC). The SBC is a network element that sits at the border between the telecommunications network and its peer telecommunications networks. It is configured to selectively allow inbound and outbound network traffic into and from the telecommunications network, respectively, based on criteria defined by the operator. The SBC has at least two network interfaces. At least one network interface of the SBC connects to the operator's core network. At least one other network interface of the SBC connects to external peer telecommunications networks. Optionally, the SBC may be an interconnect session border controller (I-SBC). An I-SBC is a type of SBC that connects two IP Multimedia Subsystems (IMS) or SIP networks that can handle voice calls. It conducts a variety of functions, including security, traffic scrubbing, address manipulation, and media transcoding.

The SCIF may either reside within the I-SBC, as a standalone network element within the telecommunications network, or in the cloud. For each inbound call, the I-SBC reads the call's SIP identifier and communicates it to the SCIF. The SCIF compares the SIP identifier with its pre-configured list of allowable identifiers. If there is a match, the SCIF identifies the inbound call as legitimate. If there is no match, the SCIF identifies the call as illegitimate. Once the SCIF identifies whether the call is legitimate or illegitimate, it instructs the I-SBC to allow or block the call, respectively. Optionally, the SCIF, upon identifying whether the call is legitimate or illegitimate, can allow or block the call respectively.

In another implementation, the I-SBC identifies an inbound call as legitimate only if it arrives at the I-SBC from an IP address range that is known to the telecommunications network operator to be allocated to a legitimate customer or business partner. If the call does not come from a known IP address range, the I-SBC determines it to be illegitimate. The I-SBC allows only legitimate calls to pass to the core network and rejects any illegitimate calls.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

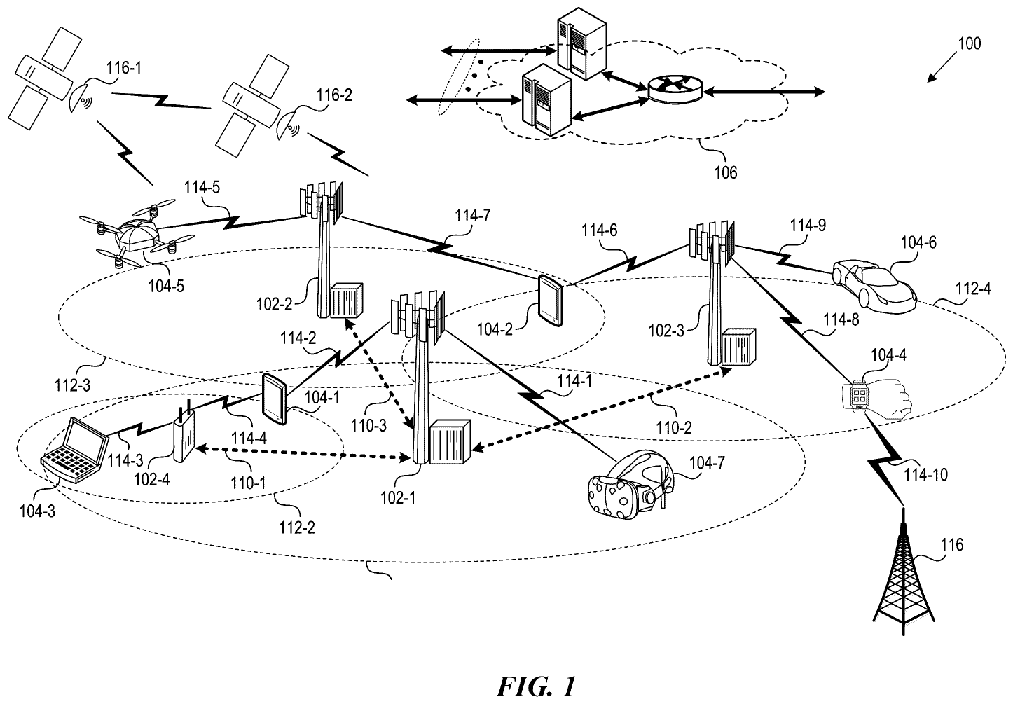

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

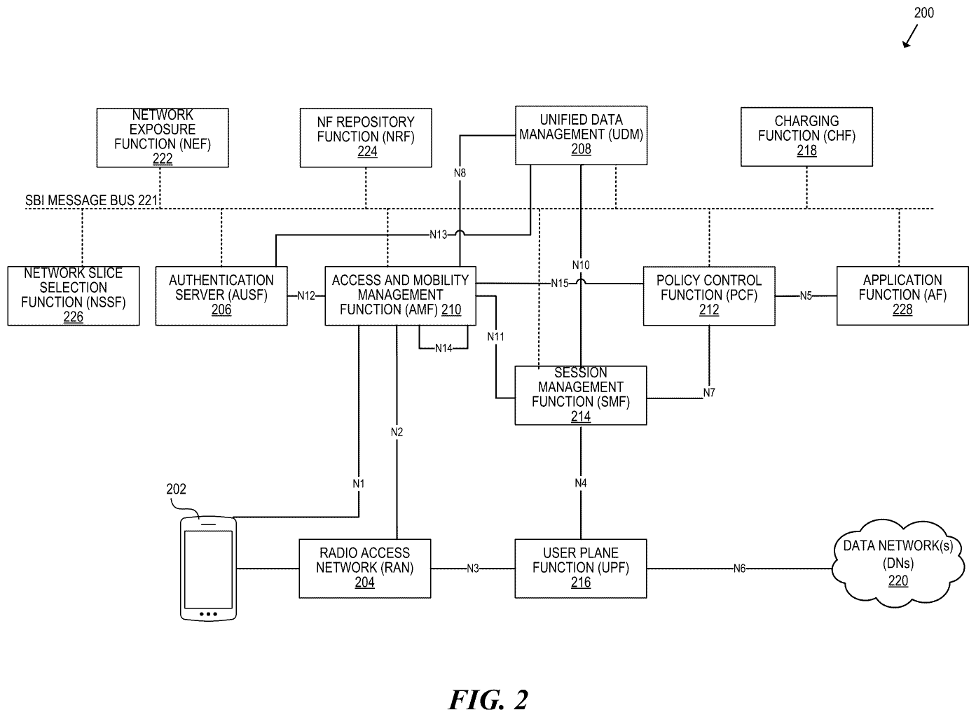

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Blocking Spoofed Calls

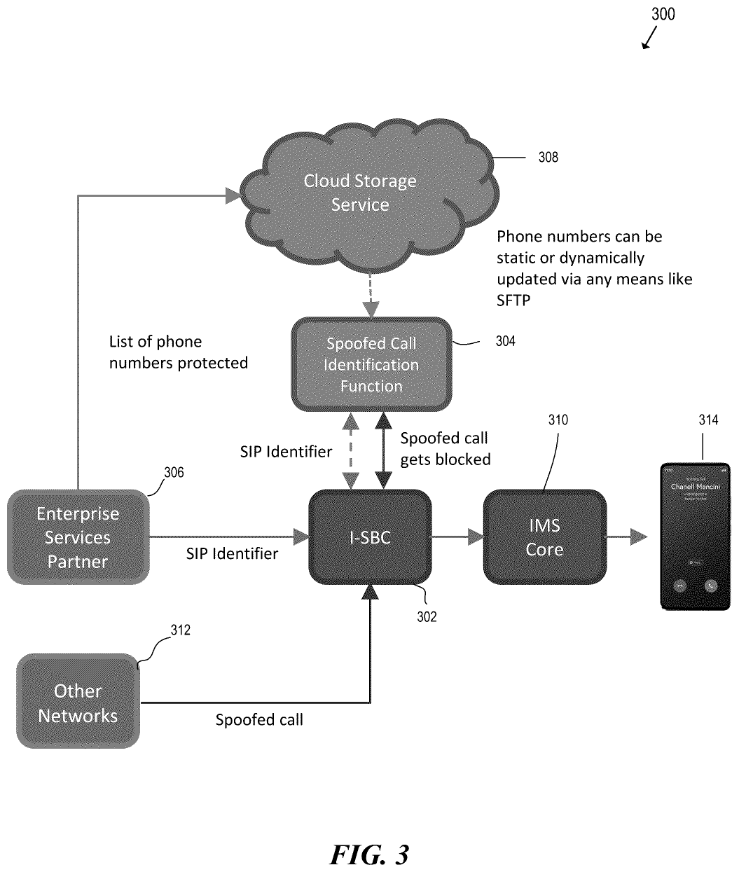

FIG. 3 is a block diagram that illustrates an example of a network 300 that can implement the present technology. As shown, an Interconnect Session Border Controller (I-SBC) 302 is a network element configured to protect Session Initiation Protocol (SIP)-based Voice over Internet Protocol (VoIP) networks by securing signaling and controlling media crossing the network. The I-SBC 302 is deployed at the border between a telecommunications network operator's network and other networks 312 that are its peers. The I-SBC 302 is also connected to external entities such as the provider's Enterprise Service Partner 306, which provides specialized value-added services to customers in addition to basic telephony services provided by the network operator.

The I-SBC 302 receives inbound calls from other networks 312 and Enterprise Service Partner 306. The I-SBC 302 performs functions such as encryption and decryption of network traffic, media handling and transcoding, and SIP interworking and forwards the calls to the network operator's IP Multimedia Subsystem (IMS) Core 310. The I-SBC 302 is configured to identify an inbound call's unique call attributes. In one embodiment, the unique call attribute can be a SIP identifier. In another embodiment, the unique call attribute can be a phone number. In yet another embodiment, the unique call attribute can be an IP address. Optionally, the I-SBC 302 is configured to identify the IP address of the network interface from which it receives an inbound call. The operator's IMS Core 310 is an Internet protocol (IP)-based network that manages Session Initiation Protocol (SIP)-based voice calls. The IMS Core 310 performs the functions of controlling, manipulating, routing, and managing multimedia sessions such as voice, video, and text messaging originating from or terminating at a user's mobile device 314.

The Spoofed Call Identification Function (SCIF) 304 is a software or hardware network element that is connected to the I-SBC 302. The SCIF 304 can be configured to store a list of allowable SIP identifiers that can be used to identify a legitimate inbound call to the I-SBC 302. The SCIF 304 receives an inbound call's SIP identifier from the I-SBC 302, compares it against the list of allowable SIP identifiers associated with legitimate calls, and sends an indication back to the I-SBC 302 whether an inbound call is legitimate or illegitimate. Optionally, the SCIF 304 can be configured as a separate hardware element in network, be collocated and integrated with the I-SBC 302, or be implemented as a software element in a Cloud Storage Service 308. Further, the list of unique call attributes can be stored within the SCIF 304 or in the Cloud Storage Service 308, from where it is accessed by the SCIF 304.

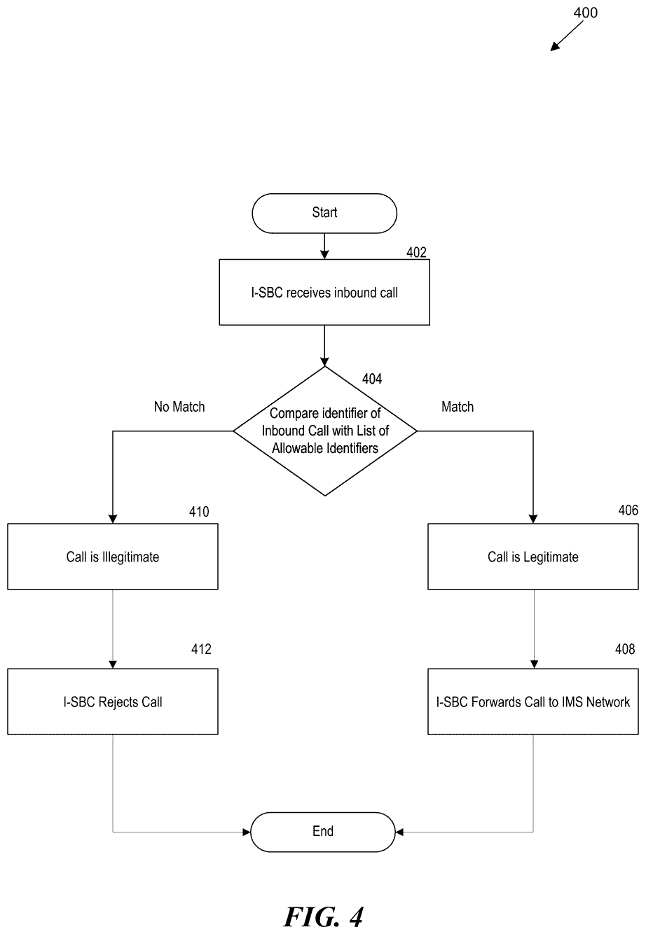

FIG. 4 is a flowchart that illustrates a process 400 for blocking spoofed calls in a telecommunications network. The process 400 is performed by a system of a telecommunications network. The system includes an I-SBC configured as a network element disposed at a border between the telecommunications network and peer telecommunications networks. The I-SBC includes at least one network interface, at least one hardware processor, and at least one non-transitory memory storing instructions, which, when executed by the at least one hardware processor, cause the I-SBC to perform the process 400.

At 402, the system can receive an inbound call over the at least one network interface. In one implementation, the inbound call is associated with a SIP identifier. The system can receive the inbound call from an enterprise services partner of the telecommunications network operator. The enterprise services partner can be configured to include in the call a unique SIP identifier known to the network operator. In another implementation, the inbound call is associated with an IP address. The IP address of the enterprise services partner from which an inbound call is received is known to the network operator. The enterprise services partner can be configured to forward the call to the network operator from a unique IP address known to the network operator.

At 404, the system can cause a comparison of the identifier of the inbound call against a list of allowable identifiers. In one example, the system can cause a SCIF to compare the SIP identifier of the inbound call against a list of allowable SIP identifiers. In another example, the system can cause an I-SBC to compare the IP address of the inbound call against a list of allowable IP addresses. In one example, the SCIF is a hardware network element in the telecommunications network. As such, the SCIF has at least one network interface that is communicatively coupled with the I-SBC. In one example, the SCIF is collocated and integrated into the I-SBC. In another example, the SCIF is implemented as a software feature in a cloud storage service. As such, the cloud storage service is communicatively coupled with the I-SBC. In one example, the list of allowable SIP identifiers is stored at the SCIF. In another example, the list of allowable SIP identifiers is stored in a cloud storage service. As such, the SCIF is communicatively coupled to the cloud storage service. In one example, the list of allowable IP addresses is stored at the I-SBC. In another example, the list of allowable IP addresses is stored in a cloud storage service. As such, the I-SBC is communicatively coupled to the cloud storage service.

At 406, the system can make a determination that a second inbound call is a legitimate call. In one example, the system receives an indication from the SCIF that the second inbound call is a legitimate call. Any inbound call associated with a SIP identifier that matches any SIP identifier on the list of allowable SIP identifiers is designated as a legitimate call. In another example, the system can receive a second inbound call at the I-SBC and cause the I-SBC to determine that this inbound call is a legitimate call. Any inbound call associated with any IP address that matches any IP address on the list of allowable IP addresses is designated as a legitimate call. In response to the determination of the legitimate call, the system can cause the I-SBC to admit the second inbound call.

At 408, in response to the system making a determination that a call is legitimate, the system can cause the I-SBC to admit the second inbound call and forward it to an IMS core network of the telecommunications network. In one example, upon receiving an indication from the SCIF that the incoming call is legitimate, the system can cause the I-SBC to forward the inbound call to the IMS of the telecommunications network. In another example, in response to identification of a legitimate call by the I-SBC, the system can cause the I-SBC to admit the second inbound call and forward it to an IMS core network of the telecommunications network.

At 410, the system can make a determination that an inbound call is an illegitimate call. In one example, the system receives an indication from the SCIF that the SIP identifier of the inbound call does not match any SIP identifier on the list of allowable SIP identifiers. Any inbound call associated with any SIP identifier that does not match any SIP identifier on the list of allowable SIP identifiers is designated as an illegitimate call. In another example, the system receives an inbound call at a network interface of the I-SBC. The system causes the I-SBC to compare the IP address of the inbound call against a list of allowable IP addresses to determine whether the inbound call is an illegitimate call. An illegitimate call is one that is received by the I-SBC from an IP address that does not match any IP address on the list of allowable IP addresses.

At 412, in response to the system making a determination that a call is illegitimate, the system rejects the inbound call. The system causes the I-SBC to reject the illegitimate call by not forwarding it to an IMS of the telecommunications network.

### Computer System

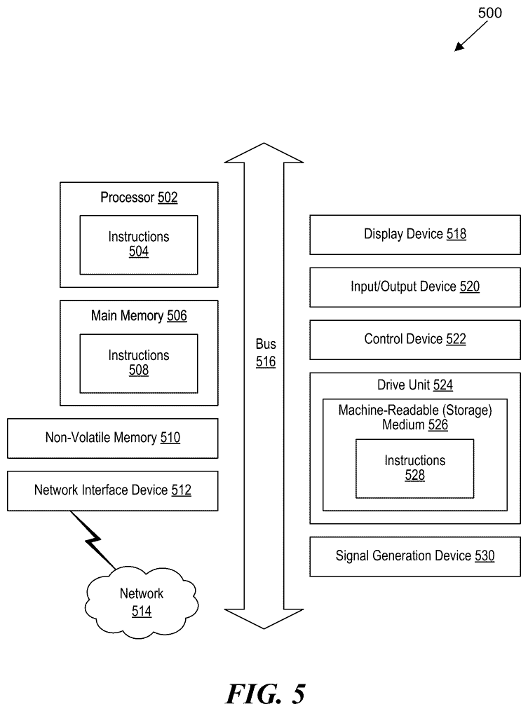

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system of a telecommunications network, the system comprising:
an interconnect session border controller (I-SBC) configured as a network element disposed at a border between the telecommunications network and peer telecommunications networks, the I-SBC including:
at least one network interface;
at least one hardware processor; and
at least one non-transitory memory storing instructions, which, when executed by the at least one hardware processor, cause the I-SBC to:
receive an inbound call over the at least one network interface,
wherein the inbound call is associated with a Session Initiation Protocol (SIP) identifier;
cause a Spoofed Call Identification Function (SCIF) to compare the SIP identifier of the inbound call against a list of allowable SIP identifiers;
receive an indication from the SCIF that the SIP identifier of the inbound call does not match any identifier on the list of allowable SIP identifiers,
wherein any inbound call associated with any SIP identifier that does not match any SIP identifier on the list of allowable SIP identifiers is designated as an illegitimate call; and
reject the inbound call as an illegitimate call,
wherein the illegitimate call is not forwarded to an IP Multimedia Subsystem (IMS) of the telecommunications network.

2. The system of claim 1, wherein the inbound call is a first inbound call, and wherein the system is further caused to:
receive a second inbound call whose SIP identifier matches at least one identifier on the list of allowable SIP identifiers;
receive an indication from the SCIF that the second inbound call is a legitimate call; and
in response to the indication of the legitimate call from the SCIF, cause the I-SBC to admit the second inbound call.

3. The system of claim 2 further caused to:
upon receiving an indication from the SCIF that the inbound call is legitimate, cause the I-SBC to forward the second inbound call to the IMS of the telecommunications network.

4. The system of claim 1, wherein to receive the inbound call over the at least one network interface comprises further causing the system to:
receive the inbound call from an enterprise services partner of a network operator of the telecommunications network,
wherein the enterprise services partner is configured to include a unique SIP identifier known to the network operator.

5. The system of claim 1, wherein to receive the inbound call over the at least one network interface comprises further causing the system to:
receive the inbound call from an enterprise services partner of a network operator of the telecommunications network,
wherein the enterprise services partner is configured to include a unique SIP identifier known to the network operator,
wherein the SCIF is a hardware network element in the telecommunications network, and
wherein the SCIF has at least one network interface that is communicatively coupled with the I-SBC.

6. The system of claim 1, wherein to receive the inbound call over the at least one network interface comprises further causing the system to:
receive the inbound call from an enterprise services partner of a network operator of the telecommunications network,
wherein the enterprise services partner is configured to include a unique SIP identifier known to the network operator, and
wherein the SCIF is collocated and integrated into the I-SBC.

7. The system of claim 1, wherein to receive the inbound call over the at least one network interface comprises further causing the system to:
receive the inbound call from an enterprise services partner of a network operator of the telecommunications network,
wherein the enterprise services partner is configured to include a unique SIP identifier known to the network operator, and
wherein the SCIF is implemented as a software feature in a cloud storage service, and
wherein the cloud storage service is communicatively coupled with the I-SBC.

8. The system of claim 1, wherein to receive the inbound call over the at least one network interface comprises further causing the system to:
receive the inbound call from an enterprise services partner of a network operator of the telecommunications network,
wherein the enterprise services partner is configured to include a unique SIP identifier known to the network operator, and
wherein the list of allowable SIP identifiers is stored in a cloud storage service, and
wherein the SCIF is communicatively coupled to the cloud storage service.

9. A system of a telecommunications network, the system comprising:
an interconnect session border controller (I-SBC) configured as a network element disposed at a border between the telecommunications network and peer telecommunications networks, the I-SBC including:
at least one network interface;
at least one hardware processor; and
at least one non-transitory memory storing instructions, which, when executed by the at least one hardware processor, cause the I-SBC to:
receive an inbound call over the at least one network interface;
compare an IP address of the inbound call against a list of allowable IP addresses;
determine that the inbound call is an illegitimate call,
wherein an illegitimate call is one which is received by the I-SBC from an IP address that does not match any IP address on the list of allowable IP addresses; and
reject the illegitimate call by not forwarding it to a telecommunications network.

10. The system of claim 9, wherein the inbound call is a first inbound call, and wherein the system is further caused to:
receive a second inbound call whose IP address matches at least one IP address on the list of allowable IP addresses;
cause the I-SBC to identify the second inbound call as a legitimate call; and
admit the call by forwarding it to a telecommunications network.

11. The system of claim 10 further caused to:
upon receiving a legitimate call, cause the I-SBC to forward the second inbound call to an IP Multimedia Subsystem (IMS) of the telecommunications network.

12. The system of claim 9, wherein to receive the inbound call over the at least one network interface comprises further causing the system to:
receive, by the I-SBC, the inbound call from an enterprise services partner of a network operator of the telecommunications network,
wherein the enterprise services partner is configured to send calls to the telecommunications network from an IP address that is known to the telecommunications network operator.

13. The system of claim 9, wherein to receive the inbound call over the at least one network interface comprises further causing the system to:
receive, by the I-SBC, the inbound call from an enterprise services partner of a network operator of the telecommunications network,
wherein the enterprise services partner is configured to send calls to the telecommunications network from an IP address that is known to the telecommunications network operator, and
wherein the list of allowable IP addresses is stored in the I-SBC.

14. The system of claim 9, wherein to receive the inbound call over the at least one network interface comprises further causing the system to:
receive, by the I-SBC, the inbound call from an enterprise services partner of a network operator of the telecommunications network,
wherein the enterprise services partner is configured to send calls to the telecommunications network from an IP address that is known to the telecommunications network operator, and
wherein the list of allowable IP addresses is stored in a cloud storage service, and
wherein the cloud storage service is communicatively coupled with the I-SBC.

15. A non-transitory, computer-readable storage medium comprising instructions recorded thereon, wherein the instructions, when executed by at least one data processor of a system, cause the non-transitory, computer-readable storage medium to cause a system of a telecommunications network comprising an interconnect session border controller (I-SBC) having at least one network interface to:
receive an inbound call over the at least one network interface of the I-SBC,
wherein a unique call attribute known to a network operator of the telecommunications network is associated with the inbound call;
cause a Spoofed Call Identification Function (SCIF) to compare the unique call attribute of the inbound call against a list of allowable unique call attributes;
cause the SCIF to determine that the inbound call's unique call attribute does not match any unique call attribute on the list of allowable unique call attributes,
wherein when the unique call attribute of the inbound call does not match any unique call attribute on the allowable unique call attribute list, the SCIF identifies the inbound call as an illegitimate call; and
cause the SCIF to reject the call by not forwarding it to a telecommunications network.

16. The non-transitory, computer-readable storage medium of claim 15, wherein when the I-SBC receives an inbound call whose unique call attribute matches at least one unique call attribute on the list of allowable unique call attributes, the system is further caused to:
determine, by the SCIF, the inbound call as a legitimate call;
cause the SCIF to admit the call by forwarding it to a telecommunications network.

17. The non-transitory, computer-readable storage medium of claim 16, wherein at least one network interface of the I-SBC is connected to an IP Multimedia Subsystem (IMS) network, and wherein the system is further caused to:
upon determination by the SCIF that the inbound call is legitimate, cause the SCIF to forward the call to the IMS network.

18. The non-transitory, computer-readable storage medium of claim 15, wherein to receive the inbound call over the at least one network interface comprises further causing the system to:
receive, by the I-SBC, the inbound call from an enterprise services partner of the telecommunications network operator,
wherein the enterprise services partner is configured to include the unique call attribute in the inbound call.

19. The non-transitory, computer-readable storage medium of claim 15, wherein to receive the inbound call over the at least one network interface comprises further causing the system to:
receive, by the I-SBC, the inbound call from an enterprise services partner of a network operator of the telecommunications network,
wherein the enterprise services partner is configured to include the unique call attribute in the inbound call, and
wherein the unique call attribute is a SIP identifier.

20. The non-transitory, computer-readable storage medium of claim 15, wherein to receive the inbound call over the at least one network interface comprises further causing the system to:
receive, by the I-SBC, the inbound call from an enterprise services partner of a network operator of the telecommunications network,
wherein the enterprise services partner is configured to include the unique call attribute in the inbound call, and
wherein the unique call attribute is an IP address.
